(19) United States
(12) Patent Application Publication
(10) Pub. No.: US 2025/0045191 A1
(43) Pub. Date: Feb. 6, 2025

(54) AUTOMATIC DRIVING TEST METHOD

(71) Applicant: CHANG'AN UNIVERSITY, Xi'an (CN)

(72) Inventors: Xiangmo ZHAO, Xi'an (CN); Lan YANG, Xi'an (CN); Shijie LI, Xi'an (CN); Fei HUI, Xi'an (CN); Zhigang XU, Xi'an (CN); Shan FANG, Xi'an (CN); Runmin WANG, Xi'an (CN); Shoucai JING, Xi'an (CN); Zhen WANG, Xi'an (CN); Rui LIU, Xi'an (CN); Bin TIAN, Xi'an (CN)

(21) Appl. No.: 18/791,298

(22) Filed: Jul. 31, 2024

(30) Foreign Application Priority Data
Aug. 1, 2023 (CN) 202310954692.2

(51) Int. Cl. G06F 11/36; G01M 17/007; G06F 11/34

(52) U.S. Cl. CPC G06F 11/3688; G01M 17/007; G06F 11/3457; G06F 11/3684

(57) ABSTRACT

The present disclosure provides an automatic driving test method. The method includes: acquiring test configuration information input by a user; generating test cases according to the test configuration information, and allocating the test cases to corresponding test types, wherein test types comprise a virtual simulation test, a whole vehicle in-loop test, a closed site test, and an open road test; and under each test type, testing a to be tested vehicle based on the corresponding test cases to obtain test results corresponding to each of the test type, and the test results comprise a simulation test result, a whole vehicle in-loop test result, a closed road test result, and an open road test result. Thus obtaining rich comprehensive test evaluation results makes the test results for autonomous vehicles more accurate.

### CROSS REFERENCE TO RELATED APPLICATION

This disclosure claims foreign priority of Chinese Patent Application No. 202310954692.2, filed on Aug. 1, 2023 in the China National Intellectual Property Administration, the disclosures of all of which are hereby incorporated by reference.

### TECHNICAL FIELD

The present disclosure relates to the technical field of vehicle test, in particular to an automatic driving test method.

### BACKGROUND

The autonomous vehicle needs to be suitable for various complex scenes, so that strict simulation tests are required before the vehicle leaves the factory, so as to ensure the use safety of the autonomous vehicle.

At present, a large number of test tools for autonomous vehicles are existed, and existing test tools are basically tested for the “local” performance of the autonomous vehicle, for example, separately testing the specific functions of the vehicle without considering the integrity of the vehicle in the actual use process, causing the existing automatic driving test tools to be independent of each other, the information island phenomenon is serious, which is not conducive to the comprehensive evaluation of the automatic driving test, so that the test result of the autonomous vehicle is not accurate enough. Therefore, a comprehensive test method for an autonomous vehicle is crucial in an automatic driving test process.

### SUMMARY

The present disclosure provides an automatic driving test method, to solve the technical problem that test results of existing autonomous vehicles are not accurate enough.

To realize the above objective, the present disclosure provides an automatic driving test method, including:
acquiring test configuration information input by a user;
generating test cases according to the test configuration information, and allocating the test cases to corresponding test types, wherein test types comprise a virtual simulation test, a whole vehicle in-loop test, a closed site test, and an open road test; and
under each test type, testing a to be tested vehicle based on the corresponding test cases to obtain test results corresponding to each of the test type, and the test results comprise a simulation test result, a whole vehicle in-loop test result, a closed road test result, and an open road test result.

The present disclosure provides an automatic driving test method. The method includes: acquiring test configuration information input by a user; generating test cases according to the test configuration information, and allocating the test cases to corresponding test types, wherein test types comprise a virtual simulation test, a whole vehicle in-loop test, a closed site test, and an open road test; and under each test type, testing a to be tested vehicle based on the corresponding test cases to obtain test results corresponding to each of the test type, and the test results comprise a simulation test result, a whole vehicle in-loop test result, a closed road test result, and an open road test result. Thus obtaining rich comprehensive test evaluation results makes the test results for autonomous vehicles more accurate.

### BRIEF DESCRIPTION OF THE DRAWINGS

FIG. 1 is a schematic structural diagram of an automatic driving test and evaluation system according to an embodiment of the present disclosure.

FIG. 2 is a flowchart of an automatic driving test method according to an embodiment of the present disclosure.

FIG. 3A is a detail flowchart of the virtual simulation test and the whole vehicle in-loop test of the automatic driving test and evaluation system according to the embodiment of the present disclosure.

FIG. 3B is a detail flowchart of the closed test and the open road test of the automatic driving test and evaluation system according to the embodiment of the present disclosure.

FIG. 4 is a first detailed flowchart of the automatic driving test method according to an embodiment of the present disclosure.

FIG. 5 is a second detailed flowchart of the automatic driving test method according to an embodiment of the present disclosure.

FIG. 6 is a schematic diagram of a hardware structure of an automatic driving test evaluation device according to embodiments of the present disclosure.

### DETAILED DESCRIPTION OF THE EMBODIMENTS

This disclosure is further described in detail below in combination with the accompanying drawings. Similar elements in different embodiments employ an associated similar element label. In the following embodiments, many details are described in order to enable the present disclosure to be better understood. However, those skilled in the art may readily recognize that some of the features may be omitted in different cases, or may be replaced by other elements, materials, methods. In some cases, some operations related to the present disclosure are not shown or described in the specification, which is to prevent the core portion of the present disclosure from being submerged by excessive description, and for a person skilled in the art, the relevant operations are not necessary in detail, and related operations can be completely understood according to the recites in the specification and common technical knowledge in the art.

In addition, the features, operations, or characteristics described in the specification may be combined in any suitable manner to form various embodiments. Meanwhile, the steps or actions in the method description can also be sequentially exchanged or adjusted in a manner obvious to a person skilled in the art. Therefore, the various sequences in the specification and the drawings are only for clear description of an embodiment, and are not intended to be in a necessary sequence, unless otherwise stated in which a certain order must be followed.

In order to solve the technical problems existed in the prior art, a test tool or a test system tests a local function of a vehicle, no complete and comprehensive test system exists, and consequently a final test result is not accurate enough is solved. This embodiment provides an automatic driving test evaluation system, and the automatic driving test evaluation system includes a plurality of local test units and a test evaluation unit, wherein the plurality of local test units are configured for testing vehicles in various actual application scenes, and the test evaluation unit is configured to perform comprehensive analysis and evaluation according to the test results fed back by each local test units to obtain a comprehensive test evaluation result of the to be tested autonomous vehicle, so that the obtained comprehensive test evaluation result is more accurate.

Furthermore, the local test units can be understood as a plurality of sub-test systems for completing the tests in different test environments for the autonomous vehicle. The local test units at least comprises a virtual simulation test unit, a whole vehicle in-loop test unit, a closed site test unit and an open road test unit. The virtual simulation test unit is used for carrying out the simulation test on the to be tested vehicle in different virtual test scenarios to obtain a simulation test result; the closed site test unit is used for testing the to be tested vehicle in the closed road test site and obtaining a closed road test result; and the open road test unit is used for testing the to be tested vehicle on the open road test site and obtaining an open road test result of the vehicle. And finally, the test evaluation unit is used for comprehensively evaluating the to be tested vehicle based on simulation test result, the whole vehicle in-loop test result, the closed road test result and the open road test result according to the to obtain a comprehensive test evaluation result of the to be tested vehicle.

It should be noted that the present disclosure merely provides several representative local test units, and in an actual test process, a technician can also add other test units according to requirements so as to test different test items of the autonomous vehicle.

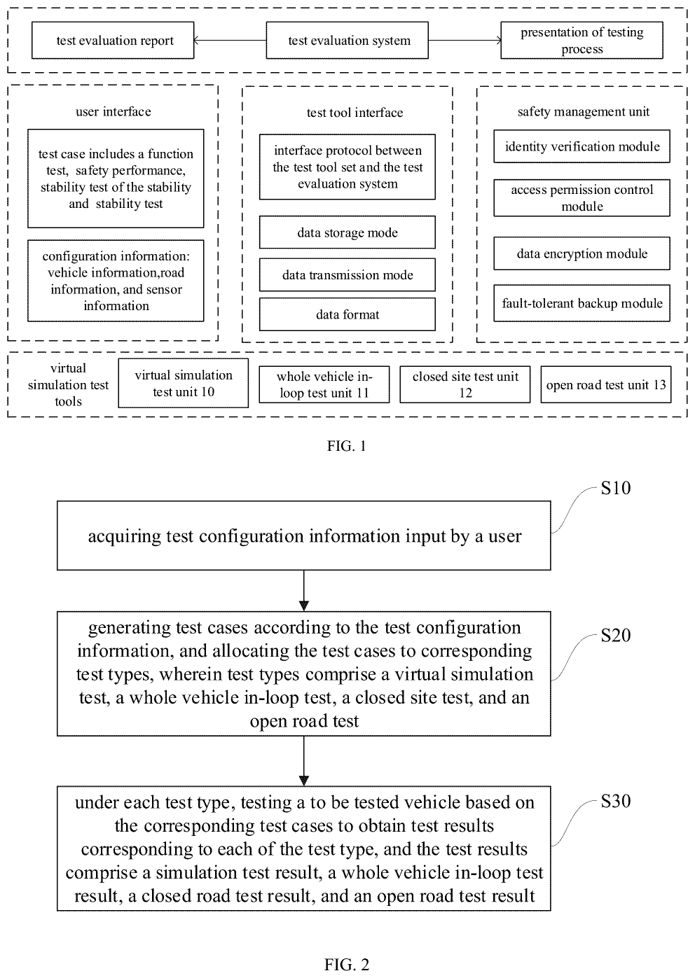

The automatic driving test evaluation system provided by the disclosure is described in detail below with reference to FIGS. 1 and 2.

### Embodiment 1

As shown in FIG. 1, the automatic driving test evaluation system provided by the embodiment 1 of the disclosure comprises a virtual simulation test unit 10, a whole vehicle in-loop test unit 11, a closed site test unit 12, an open road test unit 13 and a test evaluation unit 14.

The virtual simulation test unit 10 is used for carrying out simulation test on the to be tested vehicle in different virtual test scenarios to obtain a simulation test result.

The whole vehicle in-loop test unit 11 is used for testing the whole vehicle of the to be tested vehicle on the ring test platform, and obtaining the whole vehicle in-loop test result of the vehicle.

The closed site test unit 12 is used for testing the to be tested vehicle in a closed road test site, and obtaining a closed road test result of the vehicle.

The open road test unit 13 is used for testing the to be tested vehicle on an open road test site, and obtaining an open road test result of the vehicle.

A test evaluation unit 14 is used for comprehensively evaluating the to be tested vehicle based on simulation test result, the whole vehicle in-loop test result, the closed road test result and the open road test result according to the to obtain a comprehensive test evaluation result of the to be tested vehicle.

It can be seen that the automatic driving test evaluation system provided by the present embodiment integrates a real-time virtual simulation test, the whole vehicle in-loop test, the closed site test and the open road test, forms an automatic driving standardized test architecture of a multi-strut method, evaluates the whole system through an efficiency evaluation system, and can obtain an accurate test evaluation result.

FIG. 2 is a second schematic structural diagram of the automatic driving test and evaluation system according to the embodiment of the present disclosure. With reference to FIG. 2, the present embodiment provides four virtual simulation test tools: a virtual simulation test unit 10, a whole vehicle in-loop test unit 11, a closed site test unit 12, and an open road test unit 13. The virtual simulation test tools are provided with a cloud-based decision system simulation service. The scene library covers a standard regulation scene, an edge scene, a dangerous working condition scene and a scene automatic generation tool. The virtual simulation test tool builds a test scene according to the configuration information of the user, generates test cases, models the test vehicle, performs virtual simulation test through functional modules such as perception, decision and planning of the vehicle of the simulation test module, and finally uploads the virtual simulation test to the cloud storage.

Further, the virtual simulation test unit 10 includes a test scene generation module, a test case generation module, a to be tested vehicle construction module and a simulation test module;

The test scene generation module is used for constructing a virtual test scenario of a to be tested vehicle. The virtual test scenario includes a virtual city street scene and a virtual expressway scene. The virtual city street scene includes different types of roads, different types of crossroad intersections, such as crossroads, t-shaped intersections, roundabout islands and the like, and corresponding traffic signal lamps and signs are arranged; pedestrians and non-motor vehicles run on a sidewalk and a non-motor vehicle lane; vehicles in different types and behavior modes, such as cars, buses, trucks and the like, and random interaction behaviors among the vehicles; and environmental elements on roadside, such as buildings, trees, advertising boards, bus stations and the like. The virtual expressway scene includes different types of lanes, such as a main lane, an auxiliary lane, an emergency lane and the like; road facilities such as a guardrail, a ramp, a toll station, a server and the like; dynamic traffic flow includes vehicles of different types and speeds, lane change between vehicles, overtaking and other behaviors; and special road sections such as a curve, a ramp, a tunnel, a bridge and the like. Each virtual test scenario further includes different weather and illumination conditions such as sunny days, rainy days, foggy days, snowy days, daytime and night, low road adhesion conditions such as accumulated water road sections, icing road sections, muddy roads and the like, road construction, traffic accident sites and other special events.

According to the virtual test requirement, detailed attributes and configuration parameters required by each scene are defined, such as road type and signal lamp setting. Costracting the structure of the virtual test scenario by combining the defined scene elements. Dynamic elements such as pedestrians, non-motor vehicles and dynamic traffic flows are added into the constructed virtual test scenario, and a dynamic element two-point behavior mode and an interaction process are simulated through a script and an algorithm, for example, random lane changing and overtaking behaviors of the vehicle are set, and pedestrians crossing road and other actions are simulated. Different weather and lighting conditions, low road attachment conditions and special events are introduced into the virtual test scenario. Finally, the virtual test scenario is verified and optimized, so that each element and the dynamic elements in the virtual test scenario can normally interact, and the preset test requirement is met.

The test case generation module is used for generating test cases according to the test configuration information; and specifically, the test cases include a function test, a performance test, a safety test, a stability test and the like of the autonomous vehicle. The function test includes basic driving function testing and testing of basic driving operations such as starting, stopping, acceleration, deceleration, steering, reversing and the like; route tracking, real-time route adjustment and the like in different scenes; the environment perception test is used for testing the perception and recognition capability of the vehicle sensor on the environment information, and includes step of identifying vehicles, pedestrians, traffic signs, traffic signal lamps and the like; and performing interaction testing adopts some interaction performance, such as interaction with other vehicles, pedestrians and traffic infrastructure, such as running, lane changing, overtaking, obstacle avoidance and the like. The performance test is used to test acceleration and deceleration performance, steering performance, energy consumption performance, driving instruction and response time of environment change and the like. The safety test includes contents of collision avoidance, emergency braking, obstacle identification and avoidance and the like. The stability test includes long-term operation stability test, extreme condition test, fault processing test and the like.

According to a pre-defined test scene and a test item, specific test configuration information is input, and a corresponding test scene is generated. According to the generated test scene, detailed test steps and expected results are formulated to form a complete test case.

And the to be tested vehicle construction module is used for carrying out a vehicle modeling to generate a to be tested vehicle for the virtual test scenario. In the present embodiment, modeling software is introduced for vehicle modeling, vehicle information is read from configuration information input by a user, and a corresponding to be tested vehicle is generated based on the vehicle information. The vehicle information includes a vehicle model, appearance data, power system data, a safety system configuration, an advanced driving assistance system configuration, a sensor, a communication system configuration and the like.

And the simulation test module is used for simulating and testing the to be tested vehicle in the virtual test scenario by adopting the test cases to obtain a simulation test result.

In one or some other embodiment(s), the test scene generation module generates a test scene, the test case generation module generates a test case, the to be tested vehicle construction module models the vehicle, and finally, the simulation test module completes the virtual simulation test.

The virtual simulation test unit 10 further includes a vehicle function simulation test module which is mainly used for carrying out simulation test on specific functions of the vehicle, for example, carrying out simulation test on a perception capability, a decision capability and a planning capability of the to be tested vehicle.

Further, the automatic driving test evaluation system further includes a safety management unit.

The safety management unit includes a user identity verification module, an access permission control module, a data encryption module and a fault-tolerant backup module.

The identity verification module is used for verifying the accessed user identity information to obtain an identity verification result.

The access permission control module is used for determining whether the current user has access permission or not according to the identity verification result; when it is determined that the current user has the access permission, allowing the current user to access.

The data encryption module is used for encrypting the test data and the test results; and the test data and the test results can be encrypted by adopting an existing encryption method, for example, AES, DES, RSA, ECC, MD5 and the like.

The fault-tolerant backup module is used for carrying out data backup under the condition that a system error occurs. The data is backed up to a cloud disk or a non-volatile readable storage medium.

With the safety management unit, the identity of the user accessed in the test visit process can be determined, the identity of the current user is ensured to be legal and has access authority, the test system is prevented from being accessed by illegal users so as to steal the test information, leakage of the test information is caused. In other words, the data can be prevented from being obtained, used, modified, leaked and damaged by unauthorized acquisition, and the integrity, availability and confidentiality of the data are ensured. In addition, through the data encryption module and the fault-tolerant backup module, the safety of data of the test system is guaranteed, and therefore the overall safety of the test system is guaranteed. The data is prevented from being acquired, used, modified, leaked and damaged by unauthorized acquisition. And the integrity, availability and confidentiality of the data are ensured.

The whole vehicle in-loop test unit 11 is used for carrying out a whole vehicle in-loop test on the to be tested vehicle on the whole vehicle in-loop test platform, and uploading the whole vehicle in-loop test data to the cloud test evaluation unit 14.

The whole vehicle is in the ring test unit 11, performs a whole vehicle in-loop test on the real test vehicle, virtual test scenario data is generated by the digital twin system, a test environment is simulated by the whole vehicle in-loop test platform, inputting a virtual test scenario and sensor data to the to be tested vehicle, and the whole vehicle in-loop test of the test vehicle is completed. Specifically, the whole vehicle in-loop test unit 11 constructs a high-dimensional automatic driving data set through real traffic data, realizes the construction of a critical test scene and a twin test scene, can realize multi-dimensional dynamic test data holographic high-fidelity recording, can realize automatic generation of a flexible test scene (can realize automatic combination of scenes such as rural, sea, city, high speed and the like), has high sense of reality reproduction in the test process, and provides rich high-fidelity test scenes and dynamic interaction platforms based on the high-precision map. The whole vehicle generates test scenario data according to the test information configured by the user on the ring test platform, then the whole vehicle simulates a virtual test environment on the ring test platform, the two modules are input through hardware data simulation and scene data to carry out whole vehicle in-loop test on the to be tested vehicle, and the test data is uploaded to the local and cloud server for storage by the test vehicle. The virtual test scenario data comprises a driving mode, a driving speed, a driving scene and the like.

Further, the whole vehicle in-loop test unit 11 may include a first digital twin module, a whole vehicle in-loop test platform, a hardware data simulation module, and a scene data input module.

The first digital twin module, used for generating virtual test scenario data;
the whole vehicle in-loop test bench is used for generating a virtual test environment according to the test scenario data;
a hardware data simulation module, used for generating a virtual hardware analog signal; and
the scene data input module is used for generating virtual test scenario data.

And the closed site test unit 12 is used for carrying out a closed site test on the to be tested vehicle in the closed test site, and uploading the closed site test data and the site road side data of the to be tested vehicle to the cloud test evaluation system; a closed test site and a corresponding digital twin system are used for perform the closed site test on the to be tested vehicle based on a test environment and a route. Wherein, the test site includes roadside equipment, the data acquired by the roadside equipment is uploaded to a closed site digital twin system and subsequently uploaded to a cloud test evaluation unit 14. Specifically the closed site test unit 12 is provided with various reliability enhanced typical test roads and control stability test squares, different low adhesion coefficient pavements, climbing ramps, wading paths and other special automobile test road facilities. And a relatively complete Internet of Vehicles communication system is constructed, the Internet of Vehicles communication system includes 4G-LTE, LTE-V, Wi-Fi, 802.11p, EUHT, 5G and the like. A unmanned vehicles, intelligent connected vehicles, and unmanned vehicle indoor testing electromechanical integration system, and semi-physical simulation test platform, and a traffic signal control system, and a video monitoring system, and a UWB positioning system, and a portal frame, and a simulation tunnel, and a ground induction coil, and an ETC system, and an optical fiber network, and a high-performance server and the like are equipped, to ensure real-time information interaction between a vehicle and a road V-R, a vehicle and a vehicle V-V, a vehicle and a monitoring center V-I, a road and an information monitoring center R-I is ensured, and intelligence of a test road is achieved. The system distributes the test environment according to the user configuration and prepares the test vehicle. After the test vehicle passes the design task after the test vehicle passes the safety authentication, the test vehicle is subjected to closed site test, the test data of the vehicle is uploaded to the local and cloud server for storage by the test vehicle, and meanwhile, the roadside facility data in the closed site is uploaded to the local and cloud server for storage by the digital twin system.

Further, the closed-site test unit 12 includes a second digital twin module and a second test vehicle safety authentication module.

The second digital twinning module is used for configuring closed road test information and receiving roadside information collected by roadside equipment in the closed road test site;

And the second test vehicle safety authentication module is used for carrying out identity authentication on the vehicle tested in the closed road.

And the open road test unit 13 is used for carrying out open channel test on the test vehicle on the open road, and uploading open road test data and road side data of the vehicle to the cloud test evaluation unit. An open road and a corresponding digital twinning system is used to perform the open test of the to be tested vehicle in the open road planning test environment and the route. The road side equipment is opened, the data collected by the roadside equipment is uploaded to the open road digital twinning system, and the data is uploaded to the cloud test evaluation unit subsequently.

Specifically, the open road test unit 13 covers traffic facilities such as a tunnel, a refueling/charging station, an underground parking lot, a crossroad, a T-shaped intersection, a roundabout and the like; and test verification of various scenes, including formation driving, lane keeping assistance, adaptive cruise, automatic emergency braking, green wave vehicle speed guidance and the like, is provided for the automatic driving automobile. The system issues a test task demand according to the user configuration, a tester plans a test road and prepares a to be tested vehicle, the test vehicle performs a design task after passing the safety authentication, the to be tested vehicle is subjected to the open road test. And the test data of the to be tested vehicle is uploaded to the local and cloud server by the to be tested vehicle for storage. And meanwhile, the roadside facility data in the open road is uploaded to the local and cloud server for storage by the digital twin system.

Further, the open road test unit 13 comprises a third digital twin module and a third test vehicle safety authentication module;

A third digital twinning module is used for configuring open road test information and receiving roadside information collected by the road side equipment in the open road test site.

And the third test vehicle safety authentication module is used for carrying out identity authentication on the vehicle tested in the open road.

Further, the automatic driving test evaluation system further includes a test data management module; and the test data management module is used for visually presenting the test process and the test result.

Specifically, the test evaluation unit 14 includes a test data management module and a test evaluation model, and the test data management module analyzes and processes the test data of the cloud and visually presents the test process; and the test evaluation model evaluates the test process, evaluates the test process from the aspects of intelligence, safety, comfort, efficiency, energy consumption, defects and the like, judges whether the test passes or not, and generates a test evaluation report.

Further, referring to FIG. 1, the automatic driving test evaluation system further includes a user interface and a test tool interface. The user interface is used for a user to access a test tool set, the user selects a test case in the test process through the test interface and configures test information, the test case includes a function test, a performance test, a safety test, a stability test and the like of the autonomous vehicle, and the test information needing to be configured includes test vehicle information, test road information, vehicle sensor information and the like.

Specifically, the user interface is used for helping the user of the automatic driving test evaluation system to configure test information according to own requirements, and a test tool is used. The user needs to select the vehicle information of the test process through the user interface, including dynamic characteristics, steering characteristics, braking characteristics and the like of the vehicle, road information including curvature, gradient, texture and the like of the road, traffic information including surrounding traffic environment including other vehicles, pedestrians, traffic signals and the like, sensor information including sensors such as a camera, a laser radar, a millimeter wave radar, precision, noise, field of view and other parameters of the sensor, and a control algorithm and a test scene of the vehicle. In addition, the user also needs to select and configure the test case according to the self-generated demand, and the test case includes a function test that whether various functions of the autonomous vehicle can work normally or not is tested by identifying the road sign, the traffic signal lamp, the vehicle and the pedestrian and driving effects under different roads and weather conditions; the acceleration, the braking distance, the turning radius and the like of the vehicle under different conditions; the safety performance of the autonomous vehicle is tested by testing the reaction speed of the vehicle, the collision capability and the like in case of emergency; and the stability test of the stability of the autonomous vehicle under different road conditions and environmental conditions such as an expressway, an urban area, a mountain road and the like is tested. The selection of the test configuration can be provided by the scene library of the test tool and the use case library, and can also be customized and constructed by the test user.

The test tool interface is used for connecting and integrating mutually independent test tools, so that a user can access and use different test tools only through the user interface and the test tool interface, and the test tool interface defines contents such as an interface protocol, a data storage mode, a data transmission mode, a data format and the like between the test tool and the test evaluation system.

Specifically, the test tool interface is used for opening a data path between the test evaluation system and the test tool set, and achieving an integration of cross-platform test tool chains. The test tool interface defines a format of test data provided by the test tool, a data transmission mode, a data storage mode, and an interface protocol between the test tool set and the test evaluation system. A data format provided by the test tool needs to be unified into a JSON format and an XML format, the transmission mode is divided into two types of real-time transmission and batch transmission, the storage mode is divided into two types of local storage and cloud storage, and an interface protocol between the test tool and the test evaluation system comprises a transmission layer communication protocol TCP, an application layer protocol HTTP and the like. For the virtual simulation test process, due to the fact that the virtual simulation test process is carried out in the cloud server, a mode of real-time transmission and cloud storage can be adopted; and for the whole vehicle in-loop test, closed site test and open road test, due to the fact that the test tool is located locally, data is stored in a local storage mode, and local data is uploaded to the cloud server in a batch transmission mode.

It can be seen that the test tool set of the embodiment includes four test processes of a virtual simulation test, a whole vehicle in-loop test closed site test and an open road test, and is respectively used for virtual simulation test of the autonomous vehicle and testing and open road test of the whole vehicle in the loop test closed site so as to obtain different test results.

It can be seen that according to the automatic driving test evaluation system provided by the embodiment, a plurality of test cases can be first generated through the test evaluation unit, and the test cases are distributed to the whole vehicle in-loop test unit, the closed site test unit and the open road test unit. And the whole vehicle in-loop test unit is used for testing the whole vehicle of the to be tested vehicle on the ring test platform, and obtaining the whole vehicle in-loop test result of the vehicle; the open road test unit is used for testing the to be tested vehicle on the open road test site and obtaining an open road test result of the vehicle; and finally, the test evaluation unit evaluates the test result of the vehicle according to the whole vehicle in-loop test result, the closed road test result and the open road test result to obtain a vehicle comprehensive test evaluation result, so that the test results of the autonomous vehicle is more accurate.

### Embodiment 2

FIG. 2 is a flowchart of an automatic driving test method according to an embodiment of the present disclosure. With reference to FIG. 2, the test method includes:

S10, acquiring test configuration information input by a user.

Pre-executing the following steps before S10 for permission verification: verifying the accessed user identity information to obtain an identity verification result; determining whether the current user has an access permission or not according to the identity verification result; and if the current user has the access permission, allowing the current user to access. Wherein the identity information includes an identity ID, a name, an address and the like; and if the identity information is consistent with the registered identity information, the verification is passed, it is judged that the current user has the access permission, and a configuration information input/selection page is popped up for user input and/or selection of test configuration information. The emphasis configuration information page includes an input and/or selection area of information such as a test scene, vehicle information and a test environment.

Test configuration information entered or selected by the user based on the configuration information input page is accepted and identified.

S20, generating test cases according to the test configuration information, and allocating the test case to a corresponding test type, wherein the test type includes a virtual simulation test, a whole vehicle in-loop test, a closed site test and an open road test.

In this embodiment, the test cases can include a function test, a performance test, a safety test, a stability test and the like of the autonomous vehicle. The function test includes a basic driving function testing, which is configured for testing of basic driving operations such as starting, stopping, acceleration, deceleration, steering, reversing and the like; navigation and path planning testing, which is configured for testing the navigation ability of vehicles in different scenarios, including path selection, route tracking, real-time route adjustment, etc; an environment perception test, which is used for testing the perception and recognition capability of the vehicle sensor on the environment information, and includes the step of identifying vehicles, pedestrians, traffic signs, traffic signal lamps and the like; and aninteraction testing, including interaction with other vehicles, pedestrians and traffic infrastructure, such as running, lane changing, overtaking, obstacle avoidance and the like. The performance test includes acceleration and deceleration performance, steering performance, energy consumption performance, driving instruction and response time of environment change and the like. The safety test includes collision avoidance, emergency braking, obstacle identification and avoidance and the like. The stability test includes long-term operation stability, extreme condition test, fault processing and the like.

According to a pre-defined test scene and a test item, specific test configuration information is input, and a corresponding test scene is generated. According to the generated test scene, detailed test steps and expected results are formulated to form a complete test case.

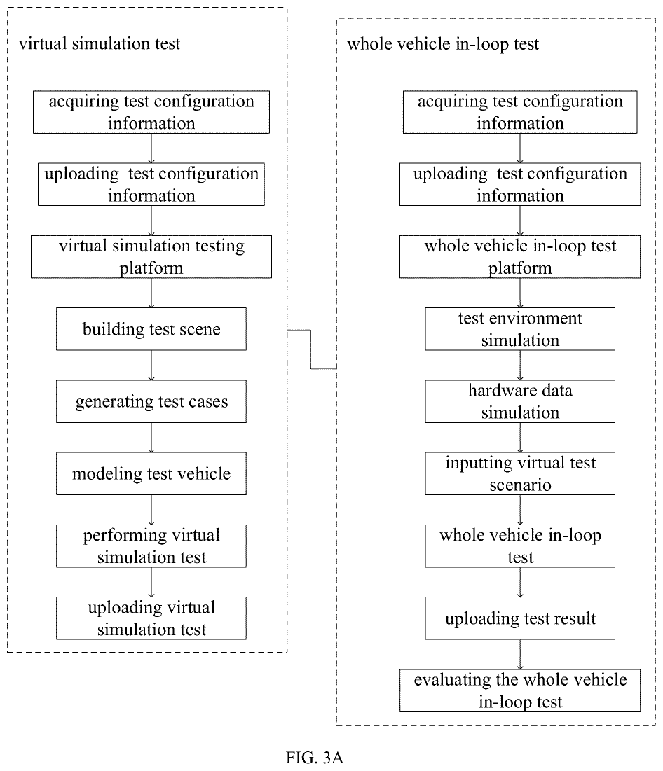

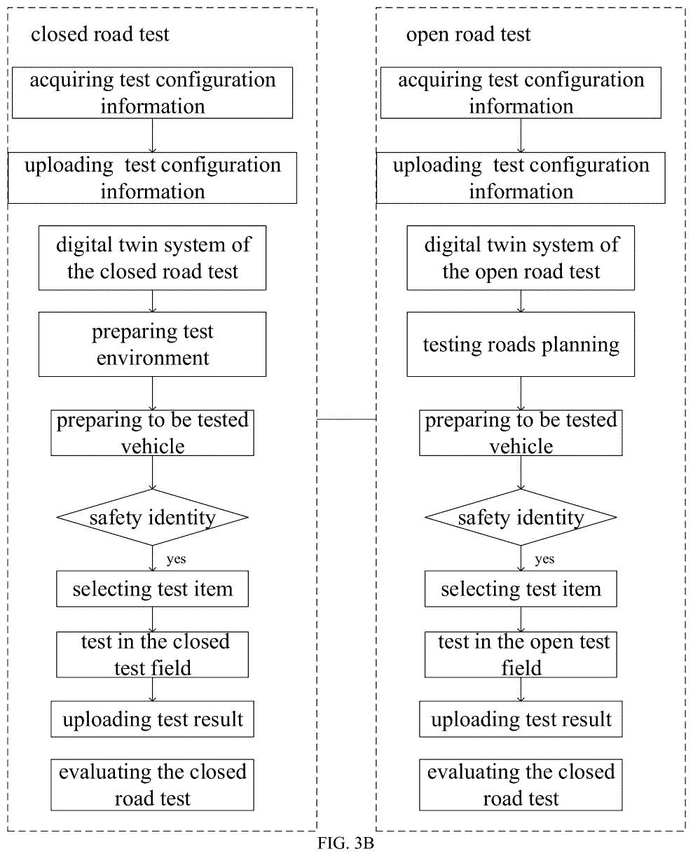

After a test case is obtained, the test case is allocated to a corresponding test type, wherein the test type includes a virtual simulation test, a whole vehicle in-loop test, a closed site test and an open road test. It will be appreciated that one test case may be assigned to multiple test types, and one test type may include multiple test cases. And the detail flowchart of virtual simulation test, the whole vehicle in-loop test, the closed site test and the open road test are shown in FIGS. 3A and 3B. FIG. 3A is a detail flowchart of the virtual simulation test and the whole vehicle in-loop test of the automatic driving test and evaluation system according to the embodiment of the present disclosure, FIG. 3B is a detail flowchart of the closed test and the open road test of the automatic driving test and evaluation system according to the embodiment of the present disclosure.

It should be noted that the virtual simulation test and the whole vehicle in-loop test are tests performed in a virtual test scenario, and the closed site test and the open road test are tests performed in a real scene.

The test configuration information includes the type of the test case. According to this embodiment, the test case can be read, and the test type is distributed according to the read result.

Specifically, the virtual simulation test creates different driving scenes and traffic environments on a computer through a high-precision three-dimensional modeling and simulation technology, is not limited by real conditions, and can carry out large-scale testing at any time, and is used for verifying the performance of the automatic driving algorithm in various complex and extreme environments, including various weather, road conditions and traffic conditions. The algorithm of the automatic driving system can be quickly iterated and optimized, the development efficiency is improved, and the risk and cost in real testing are reduced.

A whole vehicle in-loop test is to place key components (such as a controller and a sensor) of a whole vehicle or a vehicle in a virtual environment for testing. Through a hardware-in-loop simulation (HIL) technology, a virtual test scenario is combined with actual hardware equipment and is used for verifying the cooperative working performance of hardware and software of the automatic driving system in actual operation, the problems in a real scene can be accurately simulated and tested in a virtual environment, the problems in system integration can be found in advance, and the reliability and stability of the system are improved.

The closed site test is tested in a real closed test site, and the site usually has a good environment and equipment, can simulate different roads and traffic conditions, and is used for verifying the basic driving function and performance of the autonomous vehicle in a real environment, including operations such as acceleration, braking, steering, obstacle avoidance and the like. The closed site test can be used for testing various scenes in a safe and controllable environment, and the basic performance of the vehicle can be met.

The open road test is tested on a public road, the real traffic environment includes other vehicles, pedestrians and various unforeseen factors, the test conditions are more complex and changeable, and the open road test is used for verifying the performance of the automatic driving system in an actual traffic environment, evaluating the reliability and safety of the automatic driving system under various real driving conditions, comprehensively evaluating the actual operation condition of the autonomous vehicle, and providing important data and basis for final deployment of the system.

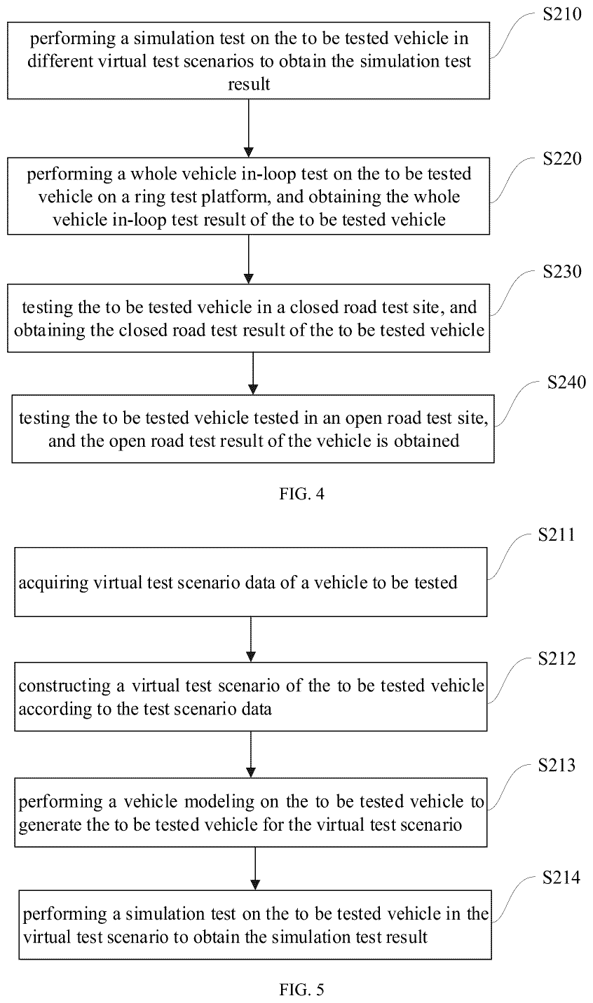

FIG. 4 is a first detailed flowchart of an automatic driving test method according to an embodiment of the present disclosure. With reference to FIG. 4, the step S20 includes:

S210, performing a simulation test on the to be tested vehicle in different virtual test scenarios to obtain a simulation test result.

Specifically, referring to FIG. 5, FIG. 5 is a second detailed flowchart of an automatic driving test method according to an embodiment of the present disclosure, and step S210 includes:

S211, acquiring virtual test scenario data of a to be tested vehicle;

The virtual test scenario may be obtained from test configuration information input by a user based on a virtual test scenario configuration page. Generally, a default basic class virtual test scenario can be set, so that the requirements of different users are met.

In the present embodiment, the virtual test scenario data include:
a road type, such as an urban street (including a main road, a secondary road, a branch, etc.), a highway (including a main lane, an auxiliary lane, an emergency lane, etc.), a rural road (including a narrow road, a road with a large curve, etc.);
Traffic conditions such as peak periods (traffic flow density and vehicle speed distribution), low peak periods (traffic flow density and vehicle speed distribution) and night driving (a vehicle lamp illumination range).

Weather conditions such as sunny days (temperature, humidity and visibility), rainy days (road adhesion coefficient and braking distance), snow (road adhesion coefficient and braking distance) and foggy days (visibility).

A road structure, such as a straight road (road width, number of lanes), a curve (turning radius, a curve length), a ramp (slope and length), a tunnel (tunnel length and lighting condition), a bridge (bridge length and bridge deck width).

Environmental elements, such as buildings, trees, traffic signs (sign types), pedestrians (number, moving speed), other vehicles (vehicle types, speeds), non-motor vehicles (non-motor vehicle types, numbers, speeds), and the like. The virtual test scenario data can be obtained from the virtual test scenario data page: a virtual test scenario data page is popped up for a user to input or select virtual test scenario data.

S212, constructing a virtual test scenario of the to be tested vehicle according to the test scenario data;

Based on the test scenario data, a high-precision three-dimensional virtual test environment is created by using a simulation platform, and the high-precision three-dimensional virtual test environment includes road topology, traffic rules, other vehicles, pedestrians and other dynamic traffic participants and environmental factors.

According to the test requirements, detailed attributes and configuration parameters required by each scene are defined, such as road type and signal lamp setting. The defined scene elements are combined, and the structure of the virtual test scenario is constructed. Dynamic elements such as pedestrians, non-motor vehicles and dynamic traffic flows are added into the constructed virtual test scenario, and a dynamic element two-point behavior mode and an interaction process are simulated through a script and an algorithm, for example, random lane changing and overtaking behaviors of the vehicle are set, and pedestrians crossing road and other actions are simulated. Different weather and lighting conditions, low road attachment conditions and special events are introduced into the scene. Finally, the virtual test scenario is verified and optimized, it is ensured that each element and the dynamic element in the scene can normally interact, and the preset test requirements are met.

S213, performing a vehicle modeling on the to be tested vehicle to generate a to be tested vehicle for the virtual test scenario.

The vehicle modeling process includes the steps of appearance modeling, power system modeling, sensor modeling and control system modeling, so that the appearance, dynamic characteristics, sensor types and positions of the to be tested vehicle in the virtual environment are kept consistent with the driving logic and the real vehicle.

The appearance modeling includes the following steps: modeling a three-dimensional model, and constructing a high-precision three-dimensional model according to the appearance data of an actual vehicle, wherein the three-dimensional model includes detail parts such as a vehicle body, wheels, a vehicle lamp and the like; and the material and the map are applied to high-quality materials and maps, so that the appearance of the virtual vehicle is close to the real vehicle as much as possible.

The power system modeling includes: an aerodynamic model which is used for simulating the air resistance borne by the vehicle in the driving process and influencing the speed and fuel efficiency of the vehicle; and a vehicle body dynamics model, which simulates the inertia of a vehicle body, the position of the center of gravity and the dynamic behavior thereof under different road conditions; and a steering system model and a working principle of a simulation vehicle steering system, and the steering system model includes a steering angle, a steering torque and the like; and an engine model, which simulates performance parameters such as power output, rotating speed and torque of an engine; and a transmission system model and a power transmission process of the simulation transmission system, and includes components such as a transmission and a differential; and a braking system model for simulating the working condition of the braking system, and analyzing the braking distance and the braking response time; and
a suspension system model, which adopts and the working principle of the simulation suspension system and affects the comfort and stability of the vehicle under different road conditions; and a wheel dynamic model for simulating dynamic characteristics such as rotation, friction force and slip rate of wheels; and a tire dynamics model is used for simulating the performance characteristics of tire grabbing force, abrasion and the like of the tire.

The sensor modeling includes a laser radar which is configured for simulating a scanning range, point cloud data and resolution of a laser radar; and a millimeter wave radar which is used for simulating parameters such as the detection distance and the speed measurement precision of the millimeter wave radar; and a camera is used for simulating the performance of the visual field, the resolution, the frame rate and the like of the camera; and an inertial measurement unit (EIU) which is configured foe simulating the acceleration and angular velocity measurement precision of an IMU; and a global positioning system (GPS) is used for simulating the characteristics of positioning precision, updating frequency and the like of a GPS.

The control system modeling includes a control algorithm which is designed and realized according to the requirements of the automatic driving system, and the control algorithm includes path planning, speed control, steering control and the like; and
a driving logic is used for simulating various operation logics in a real driving environment, such as obstacle avoidance, overtaking, lane changing and the like.

S214, performing a simulation test on the to be tested vehicle in the virtual test scenario to obtain the simulation test result.

The specific process of testing includes the following steps:
choosing test scene selection: determining a specific virtual test scenario, such as an urban street scene, driving in the peak period, overtaking of a highway scene, lane merging and the like; and selecting proper weather conditions (such as sunny days, rainy days, snowy days and foggy days) and illumination conditions (such as daytime and night) according to the test requirements); and setting key parameters for testing: setting a test duration to ensure that the performance of the vehicle in different scenes can be comprehensively evaluated; setting the driving speed range of the to be tested vehicle according to different road types and traffic conditions; specifying the specific operation of the to be tested vehicle in the test process, such as lane changing, overtaking, obstacle avoidance, emergency braking and the like; and running the to be tested vehicle: starting the to be tested vehicle in the virtual test scenario, and simulating the driving process of the to be tested vehicle under various environments and traffic conditions; and adding a dynamic element, such as other vehicles, pedestrians, non-motor vehicles and the like, and simulating the interaction behavior of the to be tested vehicle and the to be tested vehicle; and collecting and analyzing data: recording sensor data (such as a laser radar, a millimeter wave radar, a camera, an IMU, a GPS and the like) of a vehicle in a test process, a control command (such as acceleration, steering, braking and the like) and a vehicle state (such as speed, position and attitude), analyzing the collected sensor data, and evaluating the performance of the to be tested vehicle in various scenes.

S220, performing a whole vehicle in-loop test on the to be tested vehicle on a ring test platform, and obtaining a whole vehicle in-loop test result of the vehicle.
the whole vehicle in-loop test is a method for testing the whole vehicle in a virtual test environment. An actual hardware system (such as a controller, a sensor and the like) of a vehicle is connected with a software system in a virtual environment through a hardware-in-loop simulation technology for joint testing. The whole vehicle combines the advantages of virtual simulation and actual hardware testing in the loop test, and various systems of the vehicle can be comprehensively tested under the condition that real road conditions are not needed. Complex traffic scenes and environmental conditions can be simulated, and real-time response and behavior of the vehicle are evaluated.

The whole vehicle in-loop test process includes the following steps:
starting the to be tested vehicle, a test bench, a sensor dark box and a rack digital twin system; and
generating a test scenario according to the test requirements and the test target; and
adopting the digital twin system to send the road surface state to the test bench, and the test bench receives and simulates the road surface state; and
adopting the digital twin system to send a test scene to the sensor dark box, and the sensor dark box receives and simulates a test scene; and
testing a vehicle to perform self-inspection, and a digital twin system receiving a self-inspection state; and
running the whole vehicle in-loop test, and executing a predetermined test case and scene; and
receiving test data uploaded by various modules, and analyzeing the data collected during the test process, and evaluate the performance of the vehicle in the virtual environment.

S230, testing the to be tested vehicle in a closed road test site, and obtaining the closed road test result of the to be tested vehicle.

The user fills in and submits a test vehicle parameter table, and the third-party detection mechanism performs conformity check on the vehicle according to the test vehicle parameter table. And selecting a test item conforming to the test vehicle ODD and a test method according to the check result.

A monitoring platform for a vehicle or a remote control function with a network connection function is further tested and verified on the basis of a basic test item according to a selection and test function.

Testing the real to be tested vehicle test of the corresponding test item of the vehicle in the closed test field, testing all the specified scenes at a time, and if the test vehicle does not meet the requirements of any test scene, terminating the test.

Each test item is effectively tested for three times according to a test method, and if all three tests pass, it is considered that the test item has passed.

The test process is divided into two stages, a vehicle state adjustment stage and a function test stage. The test vehicle is adjusted to the test required state by an automatic driving system or a safety person in the state adjustment stage. In the function test stage, the test vehicle tests and evaluates the traffic ability of the specific automatic driving function through a preset test scene test.

During testing, scene parameters and response conditions of the to be tested vehicle in each test process need to be recorded through test data acquisition equipment and field testers. And evaluation is carried out as a test result. The data to be collected includes data carried on a test vehicle, such as data of a positioning device, an acceleration sensor, a camera and the like; equipment data installed in a closed test site, such as data of a camera, a roadside unit, an electronic traffic facility and the like; auxiliary equipment data installed on the to be tested vehicle, such as a positioning device, an acceleration sensor, a camera and the like; a vehicle control mode; a vehicle response state; vehicle light and a signal real-time state; testing the man-machine interaction state of the driver and the to be tested vehicle; testing the manual interference condition of the vehicle; testing the to be tested vehicle for different conditions such as collision, loss of control, and detachment from autonomous driving mode; testing the lighting, temperature, humidity, and weather conditions.

When a system failure or collision accident occurs in the test process and the safety personnel take over the to be test vehicle; or the to be tested vehicle can execute the corresponding driving task according to the execution requirements of the test scene, the test is finished.

In addition to test items such as dynamic driving task intervention and takeover, automatic emergency risk avoiding and the like, all tests should be completed in the automatic driving state of the test vehicle and meet the following conditions, and it is considered that the test is passed:
1) the to be tested vehicle should undergo every test items according to regulations, and meeting the requirements thereof,
2) the to be tested vehicle should be tested in one test application through all the specified mandatory projects and the selected test items;
3) the software and hardware of the to be tested vehicle should not be subjected to any change during the test;
4) in addition to the risk mitigation strategy item, the minimum risk state item and the automatic emergency risk avoiding test item, the to be tested vehicle should not violate the traffic rule;
5) the to be tested vehicle can normally use light, a windshield wiper and the like;
6) when a fault occurs in the to be tested vehicle, it should send a warning prompt in time;
7) the driving direction of the to be tested vehicle is controlled accurately and does not swing or deviate in the direction.

S240, testing the to be tested vehicle in an open road test site, and the open road test result of the vehicle is obtained.

The test main body fills in and submits a to be test vehicle parameter table, the third-party detection mechanism carries out conformity inspection on the vehicle according to the to be test vehicle parameter table, the real vehicle function detection should be carried out on the vehicle, the consistency of the vehicle and related functions provided by the related main body and the application material description content is examined, and examination is carried out by issuing a road test permission.

According to the test requirement, the to be test vehicle is tested on the open road, and the vehicle state information needs to be returned in real time through a supervision device installed on the to be test vehicle, and the vehicle state information includes a vehicle identifier (vehicle frame number or temporary driving identification information and the like), a vehicle control mode, a vehicle position, a vehicle speed, an acceleration, a driving direction and other motion states, a remote control instruction received by the vehicle and a vehicle fault condition.

During testing, parameters and response conditions of the to be test vehicle need to be recorded through the test data acquisition equipment and the field tester, and evaluation is carried out as a test result. The data to be collected includes data carried on the to be test vehicle, such as data of a positioning device, an acceleration sensor, a camera and the like; a road side unit, an electronic traffic facility and the like; a vehicle control mode; a vehicle response state; vehicle light and a signal real-time state; testing the man-machine interaction state of the driver and the test vehicle; and testing the manual interference condition of the vehicle.

When a system failure or collision accident occurs in the test process and the safety personnel take over the to be test vehicle; or the to be tested vehicle can execute the corresponding driving task according to the execution requirements of the test scene, the test is finished.

S30, under each test type, testing a to be tested vehicle based on the corresponding test cases to obtain test results corresponding to each of the test type, and the test results comprise a simulation test result, a whole vehicle in-loop test result, a closed road test result, and an open road test result.

The virtual simulation test result includes vehicle behavior data including the speed, acceleration, braking distance, steering angle and the like of a tested vehicle and a traffic participant; sensor data including detection data of sensors such as a radar, a laser radar, a camera and the like; and environment interaction data including interaction between a vehicle and other traffic participants (such as a vehicle and a pedestrian) in a virtual environment; and path planning and control data including a path planning result and a control command of the automatic driving system; and system state data including an operation state of the automatic driving system, an operation condition error log of each algorithm module and the like.

The whole vehicle in-loop test result includes: vehicle front wheel angle in the test process; TTC of the to be tested vehicle in all the test scenes, and yaw velocity of the tested vehicle in all the test scenes, and measured vehicle pitching data, and rolling data and course data of the to be test vehicle, and surrounding vehicle track information in the tested vehicle scene, and weather information in the tested vehicle scene, and tested vehicle scene inner task information.

The closed road test result includes: driving stability data including speed control, path tracking and the like; safety data including safety performance data such as collision detection, emergency braking and obstacle avoidance; and environment sensing data including sensing effects of vehicles on road signs, traffic signals, other vehicles and pedestrians; and driving strategy data including a driving strategy of the vehicle in a closed road environment, such as lane keeping, lane changing and other operations; and reliability data of the system, which is the reliability performance of the automatic driving system under long-time operation.

The open road test result includes: driving performance data including the performance of speed, acceleration, braking distance, steering angle and the like under actual road conditions; and environmental adaptability data including the adaptive performance of the vehicle under different traffic flow and weather conditions; and traffic laws and regulations which comply with the compliance of traffic regulations such as traffic signals, road signs, lane lines and the like of vehicles; and interaction behavior data including the interaction between the vehicle and other traffic participants (such as a vehicle, a pedestrian, and a bicycle); and system stability data including the stability and reliability of an automatic driving system in an actual road environment.

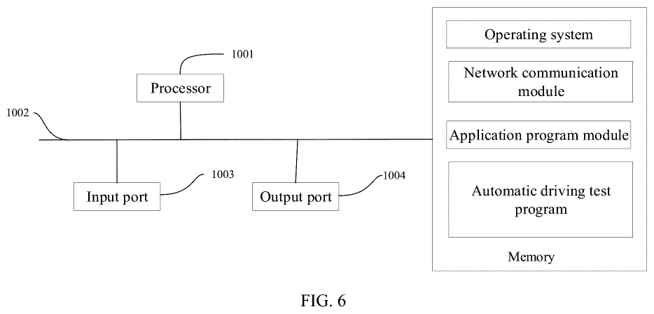

The overall flowchart of the automatic driving test method according to embodiments of the present disclosure is shown in FIG. 6. With reference to FIG. 6, the present disclosure further includes: encrypting the simulation test result, the whole vehicle in-loop test result, the closed road test result and the open road test result.

Furthermore, data backup is carried out under the condition that system errors including but not limited to sensor data loss, system crash, network connection interruption, hardware faults, software abnormity and the like are carried out, the data is backed up to the cloud memory, and the safety and recover ability of the data are ensured.

Furthermore, visual presentation is carried out on the test process.

Furthermore, according to the simulation test result, the whole vehicle in-loop test result, the closed road test result and the open road test result, the test process is evaluated from intelligence, safety, comfort, efficiency, energy consumption and defects, and a test evaluation report is generated.

The evaluation standard includes two parts of objective evaluation and subjective evaluation, and objective evaluation includes: intelligence which is used to evaluate the intelligent degree of the vehicle based on automatic driving decision, path planning, environment perception and interaction behavior of the vehicle in different scenes; and safety performance, which is evaluated based on safety data such as collision detection, emergency braking and obstacle avoidance; and safety performance includes a following distance, a relative speed, a collision time (TTC), a transverse longitudinal speed, a rear invasion time (PET) and the like; and comfort, which is used to evaluate the comfort of the to be tested vehicle based on the suspension system performance and the speed change condition of the vehicle under different road conditions, such as the transverse longitudinal acceleration, the acceleration, the in-vehicle noise level and the riding experience; and efficiency, which is as follows: based on the acceleration and deceleration performance of the vehicle, the time and mileage data of the test task are completed, and the operation efficiency of the vehicle is evaluated; and energy consumption, which is used to evaluate energy efficiency performance of the vehicle based on energy consumption data of the vehicle in different driving modes, and the energy consumption also configured for quantifying evaluation indexes under each evaluation angle, scoring the test results from different evaluation angles, analyzing weights of different evaluation angles through an analytic hierarchy process, and comprehensively evaluating scores of all the evaluation angles to obtain objective comprehensive evaluation of the test result.

And the subjective evaluation includes the safety, the high efficiency and the agility score of the expert on the test vehicle, and the subjective comprehensive evaluation of the test result is obtained according to a proportion of 50% safety, 30% high efficiency and 20% agility.

The comprehensive evaluation of the test result is obtained according to 70% objective and 30% subjective proportion in combination with the score of subjective and objective evaluation.

The automatic driving test method involved in the present disclosure is executed by an automatic driving test device.

Referring to FIG. 6, FIG. 6 is a schematic diagram of a hardware structure of an automatic driving test device according to embodiments of the present disclosure. In the embodiment of the disclosure, the automatic driving test equipment includes a processor 1001 (for example, a central processing unit), a communication bus 1002, an input port 1003, an output port 1004 and a memory 1005, wherein the communication bus 1002 is used for realizing connection and communication among the components; and the input port 1003 is used for data input; the output port 1004 is used for data output, the memory 1005 may be a high-speed RAM memory or a non-transitory computer readable memory, for example, a disk memory, and the memory 1005 may alternatively be a storage device independent of the processor 1001. A person skilled in the art may understand that the hardware structure shown in FIG. 6 does not constitute a limitation on the present disclosure, and may include more or fewer components than those shown in the figure, or combine some components, or have different component arrangements.

Continuing to refer to FIG. 6, a memory 1005 as a readable storage medium in FIG. 6 may include an operating system, a network communication module, an application program module, and an automatic driving program. In FIG. 6, the network communication module is mainly used for being connected with a server and carrying out data communication with the server; and the processor 1001 is used for calling the automatic driving program stored in the memory 1005 and executing all the steps of the automatic driving test method.

A person skilled in the art can understand that all or part of the functions of the various methods in the embodiment can be realized in a hardware mode, or can be realized in a computer program mode. When all or part of the functions in the embodiment are realized in a computer program mode, the program can be stored in a computer readable storage medium, and the storage medium can comprise a read-only memory, a random access memory, a magnetic disk, an optical disk, a hard disk and the like, and the program is executed through a computer to achieve the functions. For example, the program is stored in a memory of the device, and when the program in the memory is executed through the processor, all or part of the functions can be achieved. In addition, when all or some of the functions in the embodiments are implemented by means of a computer program, the program may also be stored in a storage medium such as a server, another computer, a magnetic disk, an optical disk, a flash disk or a mobile hard disk, and stored in a memory of a local device by means of downloading or copying, or version updating is performed on a system of a local device, and when a program in the memory is executed by means of the processor, all or some of the functions in the above embodiments can be achieved.

Finally, it should be noted that the above embodiments are only used to illustrate the technical solutions of the present disclosure and are not limited thereto. Although the present disclosure is described in detail with reference to the foregoing embodiments, a person of ordinary skill in the art should understand that the technical solutions described in the foregoing embodiments can still be modified, or some of the technical features therein can be equivalently replaced; and these modifications or replacements do not make the essence of the corresponding technical solutions separate from the spirit and scope of the technical solutions of the embodiments of the present disclosure.

What is claimed is:

1. An automatic driving test method, wherein the automatic driving test method comprising:
acquiring test configuration information input by a user;
generating test cases according to the test configuration information, and allocating the test cases to corresponding test types, wherein test types comprise a virtual simulation test, a whole vehicle in-loop test, a closed site test, and an open road test; and
under each test type, testing a to be tested vehicle based on the corresponding test cases to obtain test results corresponding to each of the test type, and the test results comprise a simulation test result, a whole vehicle in-loop test result, a closed road test result, and an open road test result.

2. The automatic driving test method according to claim 1, wherein the under each test type, testing a to be tested vehicle based on the corresponding test cases to obtain test results corresponding to each of the test type comprises:
performing a simulation test on the to be tested vehicle in different virtual test scenarios to obtain the simulation test result;
performing a whole vehicle in-loop test on the to be tested vehicle on a ring test platform, and obtaining the whole vehicle in-loop test result of the to be tested vehicle; and
testing the to be tested vehicle in a closed road test site, and obtaining the closed road test result of the to be tested vehicle;
testing the to be tested vehicle tested in an open road test site, and the open road test result of the vehicle is obtained.

3. The automatic driving test method according to claim 2, wherein the performing a simulation test on the to be tested vehicle in different virtual test scenarios to obtain the simulation test result comprises:
acquiring virtual test scenario data of a to be tested vehicle;
constructing a virtual test scenario of the to be tested vehicle according to the test scenario data;
performing a vehicle modeling on the to be tested vehicle to generate the to be tested vehicle for the virtual test scenario;
performing a simulation test on the to be tested vehicle in the virtual test scenario to obtain the simulation test result.

4. The automatic driving test method according to claim 1, wherein before the step of acquiring test configuration information input by a user, the method further comprises:
verifying accessed user identity information to obtain an identity verification result;
determining whether a current user has an access permission according to the identity verification result;
if the current user has the access permission, the current user is allowed to access.

5. The automatic driving test method according to claim 2, wherein before the step of testing the to be tested vehicle in a closed road test site, and obtaining the closed road test result of the vehicle, the method further comprises:
configuring closed road test information, and receiving roadside information collected by a roadside device in a closed road test site;
performing an identity authentication on the to be tested vehicle tested in the closed road.

6. The automatic driving test method according to claim 2, wherein before the step of testing the to be tested vehicle tested in an open road test site, and the open road test result of the vehicle is obtained, the method further comprises:
configuring open road test information, and receiving roadside information collected by a roadside device in an open road test site;
performing an identity authentication on the to be tested vehicle tested in the open road.

7. The automatic driving test method according to claim 1, wherein after the step of under each test type, testing a to be tested vehicle based on the corresponding test cases to obtain test results corresponding to each of the test type, the method further comprises:
encrypting the simulation test result, the whole vehicle in-loop test result, the closed road test result and the open road test result;
performing a data backup in an event of a system error.

8. The method according to claim 1, wherein further comprising:
performing a visual presentation on a test process.

9. The automatic driving test method according to claim 1, wherein after the step of under each test type, testing a to be tested vehicle based on the corresponding test cases to obtain test results corresponding to each of the test type, the method further comprises:
obtaining a comprehensive test evaluation result of the to be tested vehicle, according to the simulation test result, the whole vehicle in-loop test result, the closed road test result and the open road test result.

10. The automatic driving test method according to claim 1, further comprising:
evaluating a test process from intelligence, security, comfort, efficiency, energy consumption, and defects, and generating a test evaluation report.
